(19) United States
(12) Patent Application Publication
(10) Pub. No.: US 2019/0043295 A1
(43) Pub. Date: Feb. 7, 2019

(54) Voice-Activated Actuation of Automotive Features

(71) Applicant: Microchip Technology Incorporated, Chandler, AZ (US)

(72) Inventor: Wayne Liang, Smithtown, NY (US)

(73) Assignee: Microchip Technology Incorporated, Chandler, AZ (US)

(21) Appl. No.: 16/051,801

(22) Filed: Aug. 1, 2018

Related U.S. Application Data
(60) Provisional application No. 62/542,091, filed on Aug. 7, 2017.

(51) Int. Cl. G07C 9/00

(52) U.S. Cl. CPC G07C 9/00563; G07C 9/00158; G07C 9/00182; G07C 2009/00261; G05B 2219/2637; G07C 2009/00984; G05B 2219/23386

(57) ABSTRACT

A microcontroller includes a processor and instructions stored in a machine-readable medium. The instructions, when loaded and executed by the processor, cause the processor to recognize an access by a transmitter to a vehicle, recognize a voice command to open a portion of the vehicle, and, based on a combination of the recognition of the voice command and the recognition of the access by the transmitter, issue a signal to actuate a feature of the vehicle identified in the voice command.

### PRIORITY

This application claims priority to U.S. Provisional Patent Application No. 62/542,091 filed Aug. 7, 2017, the contents of which are hereby incorporated by reference in their entirety.

### TECHNICAL FIELD

The present disclosure relates to automobiles, vehicles, and peripherals and, more particularly, to an automotive voice-activated actuation of vehicle features such as trunks.

### BACKGROUND

As automotive system suppliers race to address the rigorous and constantly changing requirements of automotive original equipment manufacturers (OEMs), the evolution of alternatives for the electrical/electronic architecture also continues. Such an architecture may have several components.

Some such components are manufactured according to various industry standards. For example, the Automotive Electronics Council (AEC) has promulgated a number of different standards, such as AEC-Q100. Other standards include International Standards Organization (ISO) 26262 and International Electrotechnical Commission (IEC) 61508. These standards may apply to design, test, manufacture, disposal, and recycling of electrical and electronic systems

Devices may be manufactured according to these or other standards so as to better work within the automotive electronic context. Some of such devices may have otherwise non-standard-compliant equivalents.

Electronics in automotive designs may play an essential role in vehicle operation, user convenience, and the protection of human life. Given the widespread use of electronic systems in automotive applications, it can be difficult to understand how essential their correct operation is to the control of the vehicle. As long as these electronic systems work properly, the safety of the people in and around the vehicle depends primarily on the driver's skill and driving practices. However, equipment failure such as unintended airbag deployment may be disastrous.

Some components of electronic automotive systems may be developed according to Backbone Media-Oriented Systems Transport (MOST). The MOST network may be a time-division-multiplex network to provide data transmission with minimum latency and premium quality of service. In a multi-camera application, the cameras are synchronized via the MOST network to sample the video frames at exactly the same time with low jitter. MOST may be implemented with a single interconnection to transport audio, video data and control information.

Some components of electronic automotive systems may include universal serial bus (USB) ports and break-out-boxes. These may be used to connect a growing number of portable consumer devices with the vehicle and elements within the automobile. The USB ports may provide an interface to a wide range of industrial devices such as Wi-Fi/Wide Local Area Network and Global Positioning System (GPS) components. The USB ports may enable charging of USB devices and connectivity to a head unit.

Actuators in automotive systems may be implemented with microcontrollers. These actuators may perform intelligent tasks which enable better usability, control, precision, torque and speed.

Components of electronic automotive systems may be connected using Ethernet, particularly to external systems such as repair and diagnostic systems. Ethernet may provide a high-speed interface to download large amounts of data for software updates.

Components of electronic automotive systems may be connected using Controller Area Network (CAN) or local interconnect network (LIN) busses. CAN and LIN communication may be may be implemented in stand-alone modules or circuits, or within other elements such as microcontrollers. CAN and LIN elements may include controllers, transceivers, or software stacks.

### SUMMARY

Embodiments of the present disclosure include an article of manufacture. The article of manufacture may include instructions. The instructions, when executed by a processor or manifested in combinatorial logic configure the processor to recognize an access by a transmitter to a vehicle. The transmitter may be a key fob. The instructions may be further configured to cause the processor to recognize a voice command to open a portion of the vehicle and, based on a combination of the recognition of the voice command and the recognition of the access by the transmitter, issue a signal to actuate a feature of the vehicle identified in the voice command. In combination with any of the above embodiments, the instructions may be further configured to cause the processor to initiate voice recognition only after recognition of the access by the transmitter to the vehicle. In combination with any of the above embodiments, the instructions may be further configured to cause the processor to initiate voice recognition before recognition of the access by the transmitter to the vehicle. Initiating voice recognition before or after access by the transmitter to the vehicle may be performed on the basis of a system. Access by the transmitter to the vehicle may be based upon authorization of the transmitter. In combination with any of the above embodiments, the instructions may be further configured to cause the processor to recognize a voice command for the vehicle by identifying a word uniquely identifying the vehicle among other devices. In combination with any of the above embodiments, the instructions may be further configured to cause the processor to activate auxiliary features upon recognition of the access by the transmitter and before recognition of the voice command. In combination with any of the above embodiments, the instructions may be further configured to cause the processor to actuate the feature by opening a vehicle trunk when the transmitter is within a designated communication range of the vehicle and a user issues the voice command to open the vehicle trunk. In combination with any of the above embodiments, the instructions may be further configured to cause the processor to determine whether the voice command has been recognized within an expiration period of authentication of the access by the transmitter to the vehicle. If the voice command has not bee recognized within an expiration period of authentication, the feature might not be activated.

Embodiments of the present disclosure may include a microcontroller, processor, apparatus, chip, system, vehicle, parking structure, or other system including any of the articles of manufacture of the above embodiments.

Embodiments of the present disclosure may include methods performed by any of the articles of manufacture when executed, microcontrollers, processors, apparatuses, chips, systems, vehicles, parking structures, or other systems of the above embodiments.

### BRIEF DESCRIPTION OF THE DRAWINGS

FIG. 1 is an illustration of a system for voice-activation to actuate automotive features such as a trunk opener, according to embodiments of the present disclosure.

FIG. 2 is an illustration of a controller for voice-activation to actuate automotive features such as a trunk opener, according to embodiments of the present disclosure.

FIG. 3 is an illustration of a method for voice-activation to actuate automotive features such as a trunk opener, according to embodiments of the present disclosure.

### DETAILED DESCRIPTION

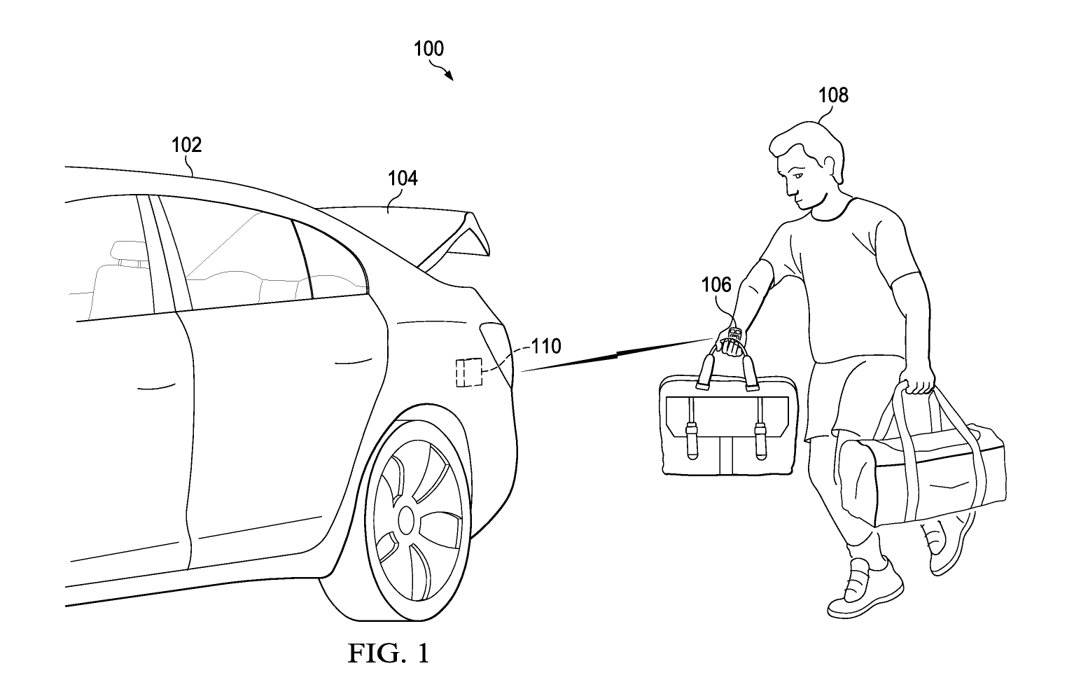

FIG. 1 is an illustration of a system 100 and a use of system 100 for a voice-activated actuation of an automotive feature such as a trunk opener, according to embodiments of the present disclosure. System 100 may be used for voice-activated automation of other portions of an automobile. System 100 may include a vehicle 102, feature 104, transmitter 106, and control module 110.

System 100 may be implemented on or for vehicle 102. Vehicle 102 may include an automobile, motorcycle, recreational vehicle, or other vehicle. System 100 may control actuation of feature 104 of vehicle 102 under certain combinations of conditions. Feature 104 may include, for example, a trunk lid, window, sunroof, light, ignition switch, side door, lift door, sliding door, or other feature of a vehicle. Actuation of feature 104 may include, for example, opening or closing a trunk lid, door, or window, or starting or stopping ignition of vehicle 102. Actuation of feature 104 may be performed by any suitable number and kind of relays, circuits, motors, or other actuators (not shown). Vehicle 102 may include any suitable number and kind of sensors, such as proximity sensors, microphones, or transceivers (not shown).

System 100 System 100 may be used by a user 108. User 102 may be a person interacting with system 100. User 108 may carry an electronic device such as transmitter 106 configured to electronically communicate with other elements of system 100. Transmitter 106 may communicate with control module 110 for actuation of feature 104.

Transmitter 106 and control module 110 may be implemented in any suitable manner. For example, control module 110 and transmitter 106 may be implemented by analog circuitry, digital circuitry, instructions on a computer-readable medium for execution by a processor, or any suitable combination thereof. Further, transmitter 106 may be implemented by a fob, smartphone, passive electromagnetic source, smart card, or near-field chip (NFC). Transmitter 106 and control module 110 may each include receivers, additional transmitters, or other mechanisms to electronically communicate with one another. For example, transmitter 106 and control module 110 may communicate over radio frequency (RF) signals when transmitter 106 and control module 110 are within a given range of one another.

In other solutions, opening feature 104 may require user 108 to shift or set down items that are carried so that keys may be inserted into locks of feature 104. Such a manual process may be replaced in other solutions wherein a key on a fob may be pressed to actuate opening of feature 104. In still other solutions, user 108 may waive a foot or a hand underneath below a bumper, wherein the bumper has a camera or proximity sensor to open a trunk implementing feature 104. However, each of these has limitations. User 108 must put objects down, physically press buttons on a fob, or stand on a single foot. Moreover, such sensors are often prone to failure. For example, such “kick sensors” might not recognize a foot that has not traversed deep enough underneath a car bumper, or may make a false-positive identification if an animal appears underneath the sensor.

In one embodiment, system 100 may allow user 108 to actuate feature 104 by the logical combination of a use of transmitter 106 and another action. In a further embodiment, the other action may be a hands-free action. For example, the action may include a voice recognition of user 108. The voice recognition may include a recognition of a vocal command to actuate feature 104. The voice recognition may include a recognition of an identity of user 108. The voice recognition might not require pressing transmitter 106. However, transmitter 106 might still be used by its possession by user 108 when performing the other action. For example, transmitter 106 might need to be within a certain range of vehicle 102 or controller module 110 when voice recognition is performed.

For example, user 108 may approach vehicle 102. User 108 may have transmitter 106 located on user 108 in, for example, a pocket. Transmitter 106 may be configured to authenticate itself to controller module 110. By proxy, transmitter 106 may authenticate a holder of transmitter 106 to vehicle 102.

The authentication may be based on any suitable cryptographic technique, such as a shared secret, or public-private key validation. Authentication may be made when transmitter 106 proves to controller module 110 that transmitter 106 is an instance of a transmitter that controller module 110 is expecting or an instance of a transmitter that is to be trusted or otherwise given access to sub-systems of vehicle 102. Thus, transmitter 106 may be configured to uniquely identify itself to controller module 110 such that controller module 110 will only actuate feature 104 or other features of vehicle 102 if transmitter 106 is authenticated. Authentication may be performed only when transmitter 106 is within range of controller module 110. Controller module 110 may be configured to not authenticate transmitter 106 when communication signals from transmitter 106 are below a designated threshold, indicating that transmitter 106 is not within a designated range. Such a threshold may be measured according to an average signal strength or other suitable criteria. Once authenticated, transmitter 106 may be authenticated for a given period of time, until transmitter 106 moves out of range, or another limit is reached.

During the approach to vehicle 102, user 108 may perform a designated action such as a vocal command for vehicle to actuate feature 104, such as opening a trunk lid. The vocal command may be, for example, “Car, open trunk”. Controller module 110 may be configured to listen for such a vocal command. In one embodiment, controller module 110 may be configured to begin listening for a vocal command after transmitter 106 is authenticated. Controller module 110 may be configured to stop listening for such a vocal command after transmitter 106 is out of range, or after a time period of, for example, ten seconds, in which transmitter 106 is not authenticated again. In another embodiment, controller module 110 may enable listening for voice commands before authentication of transmitter 106, but even though controller module 110 recognizes commands, controller module 110 may ignore or delay execution of the command until after the authentication occurs. In such a case, controller module 110 may set a time period in which subsequent authentication must occur, such as ten seconds.

Controller module 110 may process input signals from a sensor (not shown) such as a microphone. The microphone may be located, for example, on a trunk lid above a license plate area to prevent damage or interference by accumulated precipitation such as snow or ice.

Once transmitter 106 is authenticated, auxiliary features may also be actuated. For example, when transmitter 106 is authenticated, periphery lights near handles of vehicle 102, running lights, a license plate light, or brake lights may be activated by controller module 110. In one embodiment, auxiliary features may be actuated when a different feature is instructed to be actuated after transmitter authentication. For example, after receiving a command of “Car, open trunk”, and after authentication of transmitter 106, controller module 110 may be configured to turn on a license plate light, running lights, or brake lights. In another embodiment, auxiliary features may be turned off if a recognized voice command is not received within a designated time period.

In some embodiments, transmitter 106 authentication might not be hands-free. Transmitter 106 authentication may separately require pressing a button or holding a finger to a fingerprint recognition sensor on transmitter 106. Only after pressing the button or authenticating the fingerprint in such cases might transmitter 106 authentications be initiated or performed.

Controller module 110 may be configured to perform processing of captured audio from user 108. Controller module 110 may be configured to recognize words spoke, parse recognized words into phrases, and apply state models of possible commands forming grammar matching to identify command phrases that may then be executed. Such commands may include “open door”, “open trunk”, “close door”, “close trunk”, “open window”, “close window”, “open sunroom”, “close sunroom”, “turn on lights”, “turn off lights”, “unlock door”, “lock door”, “start car”, “find car” (causing illumination), etc. In one embodiment, a particular instance of vehicle 102 may be addressed by a specific identifier. For example, user 108 may have given a name or other identifier to the user's specific instance of vehicle 102. In one embodiment, controller module 110 may parse received audio signals for an address to the specific instance of vehicle 102 and require such an address as part of authentication. For example, if the user's vehicle is named “Blue Acme Car”, a command intended for the vehicle may be preceded with the phrase “Blue Acme Car” followed by the specific command. If so configured to require addressing of the specific instance of vehicle 102, controller module 110 may ignore all instructions that do not include the phrase addressing the specific instance of vehicle 102.

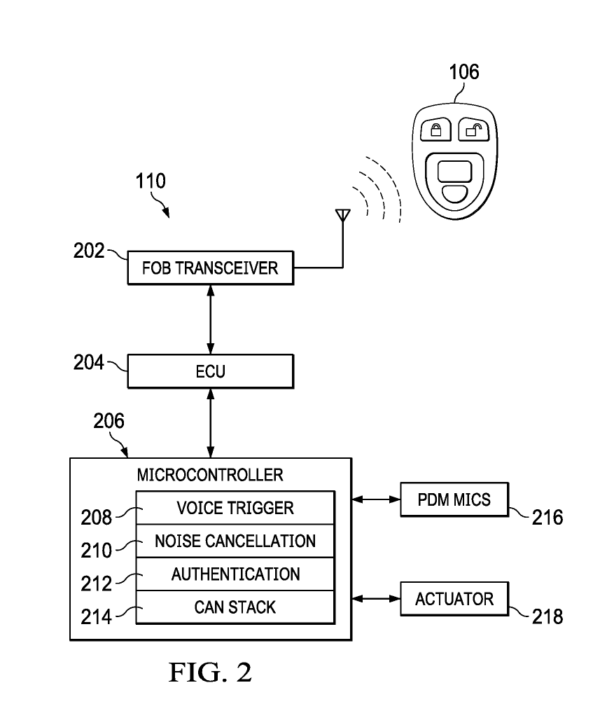

FIG. 2 is a more detailed illustration of controller module 110, according to embodiments of the present disclosure. In one embodiment, controller module 110 may be implemented near the location of actuation of a feature of the vehicle. For example, controller module 110 may be implemented in the rear of the vehicle if controller module 110 is to control opening of a trunk lid.

Transmitter 106 may come into sufficient range of an antennae 220 of controller module 110. Antennae 220 may receive RF signals from transmitter 106 and communicate RF signals received from transmitter 106 to a fob transceiver 202. Fob transceiver 202 may be implemented in any suitable manner, such as by analog circuitry, digital circuitry, firmware, or an ATA57XX or ATAK51004 available from MICROCHIP TECHNOLOGY. Fob transceiver 202 may be configured to perform remote keyless entry (RKE), passive entry passive start (PEPS), and immobilizer (IMM) applications. Fob transceiver 202 may be configured to send signals from the rest of the system to transmitter 106.

Fob transceiver 202 may be communicatively coupled to an engine control unit (ECU) 204 that may be implemented with suitable analog circuitry, digital circuitry, microprocessors, microcontrollers, or other computing circuitry. Fob transceiver 202 and ECU 204 may be coupled with LIN or other suitable connection or bus. ECU 204 may be configured to manage communication with other parts of the system.

ECU 204 may be communicatively coupled to a microcontroller 206. Although a microcontroller is shown in FIG. 2, any suitable processor may be used in implementation of the system, such as a field-programmable gate array, an application-specific integrated circuit, or other processor implementations. Microcontroller 206 may be implemented by, for example, a SAMV71 or SAMV72 Cortex-M7 based microcontroller. ECU 204 and microcontroller 206 may be coupled through a CAN bus or other suitable network or bus.

Microcontroller 206 may be communicatively coupled to one or more microphones 216 mounted on the vehicle. Microphone 216 may be implemented by, for example, a pulse-density modulation (PDM) microphone. In addition, microcontroller 206 may be communicatively coupled to other sensors (not shown).

Microcontroller 206 may be communicatively coupled to one or more actuators 218. Actuator 218 may be implemented by any suitable electronic circuit, electronic device, or electromechanical device. For example, actuator 218 may include relays, circuits, or motors. Actuator 218 may be used, for example, to open a trunk lid. Microcontroller 206, actuator 218, and microphone 216 may be communicatively coupled using a CAN bus or other suitable network or bus.

Microcontroller 206 may implement any suitable software to analyze signals and actuate features of the vehicle. For example, microcontroller 206 may include a CAN stack 214 configured to facilitate communications with ECU 204 and sensors and actuators. CAN stack 214 may translate data or commands between these entities and other software on microcontroller 206. Microcontroller 206 may include an authentication program 212 configured to verify that transmitter 106 has been authenticated. Microcontroller 206 may include a noise cancellation program 210 configured to cancel ambient or background noise from signals received from microphone 216. Microcontroller 206 may include a voice trigger program 208 configured to analyze input from microphone 208 to determine whether a voice command has been received. The software may be implemented by programs, libraries, functions, algorithms, scripts, executables, applications, or any other instructions for execution by a processor. The software may be stored in a memory.

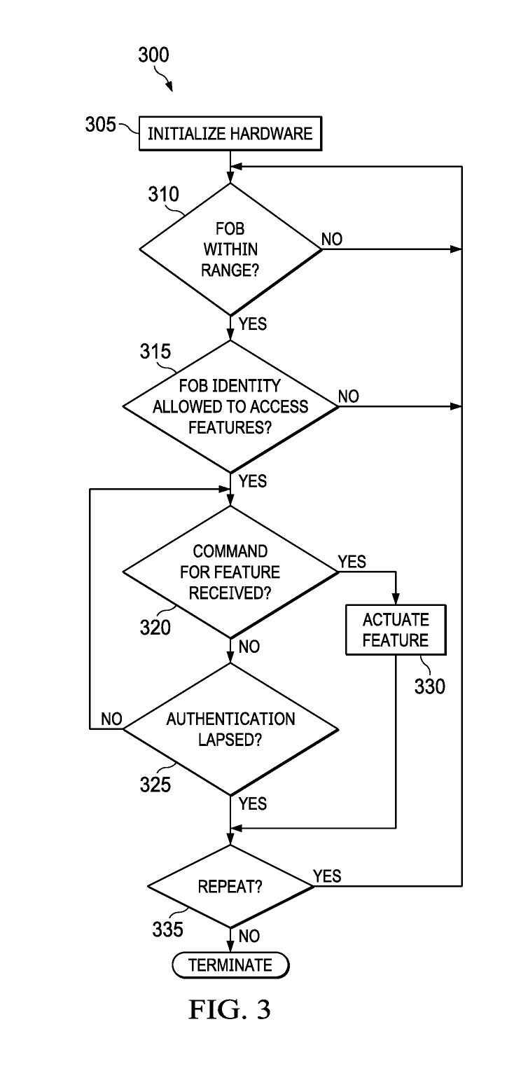

FIG. 3 is an illustration of a method 300 for voice-activation to actuate automotive features such as a trunk opener, according to embodiments of the present disclosure. Method 300 may implement operation of controller 110. Method 300 may be performed by instructions on a non-transitory, machine-readable medium that are loaded and executed on a processor. Method 300 may be performed with more or fewer steps than shown in FIG. 3. Various steps of method 300 may be omitted, performed in parallel with other steps of method 300, repeated, or repeated recursively. Method 300 may begin at any suitable point, such as at 305.

At 305, hardware for a system to actuate automotive features may be initialized. Settings may be determined, such as what features are available. Communication may be established with actuators and sensors.

At 310, it may be determined whether a fob or other transmitter for the vehicle features is within a designated range. This may be determined by, for example, comparing signal strength of received RF signals against a threshold. If not, method 300 may proceed to 335. Otherwise, method 300 may proceed to 315.

At 315, it may be determined whether the fob or other transmitter is known to be allowed to access one or more vehicle features. This authentication may be performed by, for example, a shared secret or public-private key authentication. Authentication, and subsequent steps of method 300, may be performed multiple times for different features. If not, method 300 may proceed to 335. Otherwise, method 300 may proceed to 320. In one embodiment, after authentication, auxiliary features that need no voice command may be actuated.

At 320, it may be determined whether a command for a given feature has been received. In one embodiment, listening for such a command might only be initiated upon authentication in 315. The command may require uniquely addressing the vehicle. If no correct command is successfully received, method 300 may proceed to 325. If a correct command is received, method 300 may proceed to 330.

At 325, it may be determined whether authentication has lapsed. Such a lapse may arise from, for example, a time elapsed since authentication was made or a fob or other transmitter moving out of range. To determine whether the fob or other transmitter has moved out of range, RF signal levels may be checked against a threshold, or it may be determined whether the fob or other transmitter is still connected and relaying information. If authentication has not lapsed, method 300 may return to 320. Otherwise, method 300 may proceed to 335.

At 330, the feature may be actuated. This may be performed by issuing commands to a driver, relay, motor, controller, or other suitable electrical or electromechanical device or component. Method 300 may proceed to 335.

At 335, if the feature was not specifically actuated, an attempted actuation may be denied. It may be determined whether method 300 will repeat. If so, method 300 may return to, for example, 310. Otherwise, method 300 may terminate.

Although particular embodiments have been illustrated in the present disclosure, additions, modifications, subtractions, and other alterations may be made to the example embodiments of the present disclosure without departing from the spirit and teachings of the present disclosure.

1. A microcontroller comprising:
a processor; and
instructions stored in a machine-readable medium, the instructions, when loaded and executed by the processor, cause the processor to:
recognize an access by a transmitter to a vehicle;
recognize a voice command to open a portion of the vehicle; and
based on a combination of the recognition of the voice command and the recognition of the access by the transmitter, issue a signal to actuate a feature of the vehicle identified in the voice command.

2. The microcontroller of claim 1, wherein the processor is further caused to initiate voice recognition only after recognition of the access by the transmitter to the vehicle.

3. The microcontroller of claim 1, wherein the processor is further caused to initiate voice recognition before recognition of the access by the transmitter to the vehicle.

4. The microcontroller of claim 1, wherein the processor is further caused to recognize a voice command for the vehicle by identifying a word uniquely identifying the vehicle among other devices.

5. The microcontroller of claim 1, wherein the processor is further caused to activate auxiliary features upon recognition of the access by the transmitter and before recognition of the voice command.

6. The microcontroller of claim 1, wherein the processor is further configured to actuate the feature by opening a vehicle trunk when the transmitter is within a designated communication range of the vehicle and a user issues the voice command to open the vehicle trunk.

7. The microcontroller of claim 1, wherein the processor is further configured to determine whether the voice command has been recognized within an expiration period of authentication of the access by the transmitter to the vehicle.

8. An article of manufacture comprising a non-transitory machine-readable medium, the medium including instructions, the instructions, when loaded and executed by a processor, cause the processor to:
recognize an access by a transmitter to a vehicle;
recognize a voice command to open a portion of the vehicle; and
based on a combination of the recognition of the voice command and the recognition of the access by the transmitter, issue a signal to actuate a feature of the vehicle identified in the voice command.

9. The article of claim 8, further comprising instructions configured to cause the processor to initiate voice recognition only after recognition of the access by the transmitter to the vehicle.

10. The article of claim 8, further comprising instructions configured to cause the processor to initiate voice recognition before recognition of the access by the transmitter to the vehicle.

11. The article of claim 8, further comprising instructions configured to cause the processor to recognize a voice command for the vehicle by identifying a word uniquely identifying the vehicle among other devices.

12. The article of claim 8, further comprising instructions configured to cause the processor to activate auxiliary features upon recognition of the access by the transmitter and before recognition of the voice command.

13. The article of claim 8, further comprising instructions configured to cause the processor to actuate the feature by opening a vehicle trunk when the transmitter is within a designated communication range of the vehicle and a user issues the voice command to open the vehicle trunk.

14. The article of claim 8, further comprising instructions configured to cause the processor to determine whether the voice command has been recognized within an expiration period of authentication of the access by the transmitter to the vehicle.

15. A method of controlling a vehicle, comprising:
recognizing an access by a transmitter to the vehicle;
recognizing a voice command to open a portion of the vehicle; and
based on a combination of the recognition of the voice command and the recognition of the access by the transmitter, issuing a signal to actuate a feature of the vehicle identified in the voice command.

16. The method of claim 15, further comprising initiating voice recognition only after recognition of the access by the transmitter to the vehicle.

17. The method of claim 15, further comprising initiating voice recognition before recognition of the access by the transmitter to the vehicle.

18. The method of claim 15, further comprising recognizing a voice command for the vehicle by identifying a word uniquely identifying the vehicle among other devices.

19. The method of claim 15, further comprising activating auxiliary features upon recognition of the access by the transmitter and before recognition of the voice command.

20. The method of claim 15, further comprising actuating the feature by opening a vehicle trunk when the transmitter is within a designated communication range of the vehicle and a user issues the voice command to open the vehicle trunk.
